(19) United States
(12) Patent Application Publication
(10) Pub. No.: US 2026/0281842 A1
(43) Pub. Date: Sep. 17, 2026

(54) CONDITIONAL LAYER 1 (L1) MEASUREMENTS

(71) Applicant: Apple Inc., Cupertino, CA (US)

(72) Inventors: Qiming LI, Beijing (CN); Dawei ZHANG, Saratoga, CA (US); Jie CUI, San Jose, CA (US); Yang TANG, San Jose, CA (US); Rolando E. BETTANCOURT ORTEGA, Munich (DE)

(73) Assignee: Apple Inc., Cupertino, CA (US)

(21) Appl. No.: 19/167,533

(22) PCT Filed: Apr. 6, 2023
(86) PCT No.: PCT/CN2023/086524

§ 371 Date: Sep. 22, 2025

(51) Int. Cl. H04W 36/00; H04W 36/32; H04W 36/36

(52) U.S. Cl. CPC H04W 36/00837; H04W 36/0058; H04W 36/00692; H04W 36/0088; H04W 36/322; H04W 36/362

(57) ABSTRACT

Some embodiments include a system, apparatus, article of manufacture, method, and/or computer program product and/or combinations and sub-combinations thereof, for conditional layer 1 (L1) measurements. Some embodiments include a user equipment (UE) that can receive a configuration signal including an activation/deactivation condition for conditional layer 1 (L1) measurements, and determine that the activation/deactivation condition is satisfied for a target cell. The UE can activate/deactivate a conditional L1 measurement corresponding to the target cell. In some embodiments, responsive to an activated conditional L1 measurement satisfying a threshold value, the UE can initiate a cell switch to the target cell. In some embodiments, the activation/deactivation is based on a layer 3 (L3) measurement corresponding to the target cell, a location of the UE, or a determined time corresponding to the UE.

### BACKGROUND

### Field

The described embodiments relate generally to inter-cell mobility in a wireless communications system.

### Related Art

Wireless communications systems support inter-cell mobility between a base station (BS) and a communications device such as a user equipment (UE).

### SUMMARY

Some embodiments include a system, apparatus, article of manufacture, method, and/or computer program product and/or combinations and sub-combinations thereof, for conditional layer 1 (L1) measurements. Some embodiments include a user equipment (UE) that can receive a configuration signal comprising an activation condition for conditional layer 1 (L1) measurements, and determine that the activation condition is satisfied for a target cell. The UE can activate a conditional L1 measurement corresponding to the target cell. The UE can obtain data corresponding to the activated conditional L1 measurement, and transmit the data to the network (e.g., via the serving cell base station.).

In some embodiments, to determine that the activation condition is satisfied, the UE can compare a layer 3 (L3) measurement corresponding to the target cell with a corresponding L3 measurement of a serving cell, and determine that the comparison satisfies a threshold value. In some examples, to determine that the activation condition is satisfied, the UE can determine a location of the UE, and determine that a relative distance of the location from the target cell satisfies a threshold value. In some examples, to determine that the activation condition is satisfied, the UE can determine a location of the UE, and determine a time, based at least on the location of the UE, to initiate the activation condition for the target cell.

In some examples, the UE can determine that a deactivation condition is satisfied for the target cell, and deactivate the conditional L1 measurement corresponding to the target cell. In some embodiments when an indication of the conditional L1 measurement is a semi-persistent indication, the UE can receive a radio resource control (RRC) signal comprising a change in the carrier aggregation (CA)/dual connectivity (DC) of a serving cell, and transmit an updated conditional L1 measurement capability in response to the RRC signal. In some embodiments, when the indication of the conditional L1 measurement is a dynamic indication, the UE can receive a media access control (MAC) control element (CE) signal comprising a change in carrier aggregation (CA)/dual connectivity (DC) of a serving cell, and transmit an updated conditional L1 measurement capability in response to the MAC CE signal.

Some embodiments include a base station (BS) that can receive one or more conditional L1 measurement capabilities corresponding to a UE, and transmit a configuration signal comprising an activation condition corresponding to the one or more conditional L1 measurement capabilities. The BS can receive a conditional L1 measurement corresponding to a target cell and based on the activation condition.

In some embodiments, the activation condition corresponds to a L3 measurement of a serving cell of the BS and a L3 measurement corresponding to the target cell. In some examples, the L3 measurement of the serving cell comprises a reference signal received power (RSRP) or a signal to interference plus noise ratio (SINR). In some embodiments, the activation condition corresponds to a location of the UE and a distance of the location from the target cell.

In some examples, when an indication of a conditional L1 condition is semi-persistent, the BS can transmit an RRC signal comprising a change in carrier aggregation or dual connectivity (CA/DC) corresponding to a serving cell, and receive an updated conditional L1 measurement capability of the one or more conditional L1 measurement capabilities in response to the RRC signal. In some embodiments, when an indication of a conditional L1 condition is dynamic, the BS can transmit a MAC CE signal comprising a change in carrier aggregation CA/DC corresponding to a serving cell, and receive an updated conditional L1 measurement capability of the one or more conditional L1 measurement capabilities in response to the MAC CE signal.

### BRIEF DESCRIPTION OF THE FIGURES

The accompanying drawings, which are incorporated herein and form part of the specification, illustrate the presented disclosure and, together with the description, further serve to explain the principles of the disclosure and enable a person of skill in the relevant art(s) to make and use the disclosure.

FIG. 1 illustrates an example system for conditional layer 1 (L1) measurements, in accordance with some embodiments of the disclosure.

FIG. 2 illustrates a block diagram of an example wireless system for conditional L1 measurements, according to some embodiments of the disclosure.

FIG. 3A illustrates an example activation of a conditional L1 measurement, according to some embodiments of the disclosure.

FIG. 3B illustrates an example deactivation of a conditional L1 measurement, according to some embodiments of the disclosure.

FIG. 4 illustrates an example of signaling for conditional L1 measurements, according to some embodiments of the disclosure.

FIG. 5 illustrates examples of user equipment (UE) capabilities for conditional L1 measurements, according to some embodiments of the disclosure.

FIG. 6 is an example computer system for implementing some embodiments or portion(s) thereof.

FIG. 7 illustrates an example of measurements for a handover, according to some embodiments of the disclosure.

FIG. 8 illustrates an example method for a UE supporting conditional L1 measurements, according to some embodiments of the disclosure.

FIG. 9 illustrates an example method for a base station (BS) supporting conditional L1 measurements, according to some embodiments of the disclosure.

The presented disclosure is described with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION

Some embodiments include a system, apparatus, article of manufacture, method, and/or computer program product and/or combinations and sub-combinations thereof, for conditional layer 1 (L1) measurements. To support L1/layer 2 (L2) triggered inter-cell mobility (LTM), a user equipment (UE) may need to perform L1 measurements on a neighbor cell.

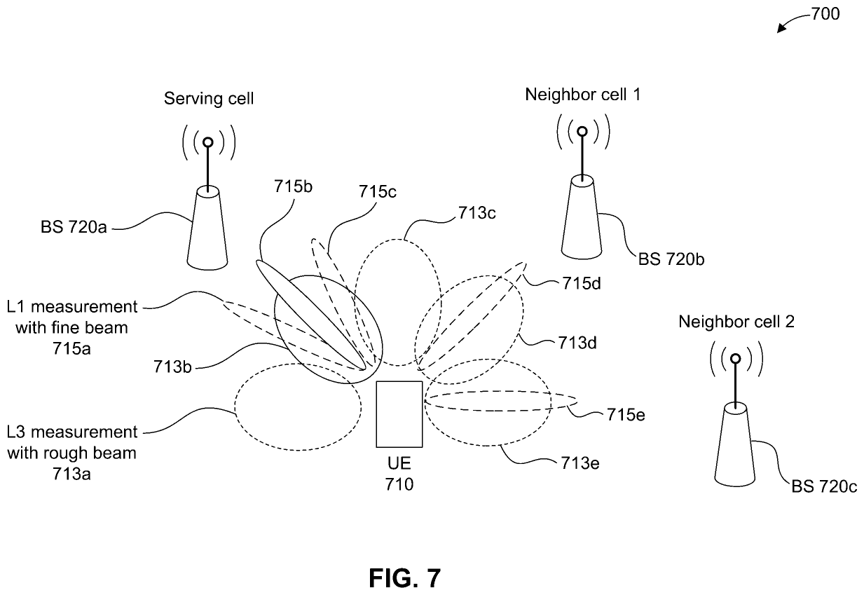

FIG. 7 illustrates example 700 of measurements for a handover, according to some embodiments of the disclosure. Example 700 may include UE 710, and base stations (BSs) 720a-720c that connect to the Internet. UE 710 may use rough beams for cell searches and layer 3 (L3) measurements 713a-713e to select BS 720a as the serving cell and find candidate target cells (e.g., neighbor cell 1 and neighbor cell 2.) After the rough beams, UE 710 can begin using fine beams 715a-715c to obtain L1 measurements for the serving cell. UE 710 can also use fine beams 715d-715e (many more 715 fine beams may be used but only a few are shown to simplify the illustration) to obtain L1 measurements from neighbor cells 1 and 2 to determine channel quality, and determine whether a neighbor cell might be a target cell to which UE 710 may perform a cell switch (e.g., handover). Fine beams have a narrower beamwidth than respective rough beams, as will be understood by those skilled in the arts. Accordingly, sweeping the fine beams to find and measure L1 measurements corresponding to the neighbor cells 1 and 2 results in unnecessary L1 measurements that can jeopardize system throughput in example 700. For example, BS 720a as the serving cell may configure L3 and L1 measurements for UE 710 via radio resource control (RRC) signaling. After receiving the RRC signals, UE 710 begins L1 measurements on neighbor cells. The fine beam training latency to perform fine beam training increases measurement latency at UE 710, which can cause delays in performance (e.g., system throughput) as measurements are transmitted to BS 720a. Further, UE 710 consumes power to perform and report the measurements. To address the above problems regarding latency, system throughput, and power consumption, some embodiments include configuring a UE with conditional L1 measurements.

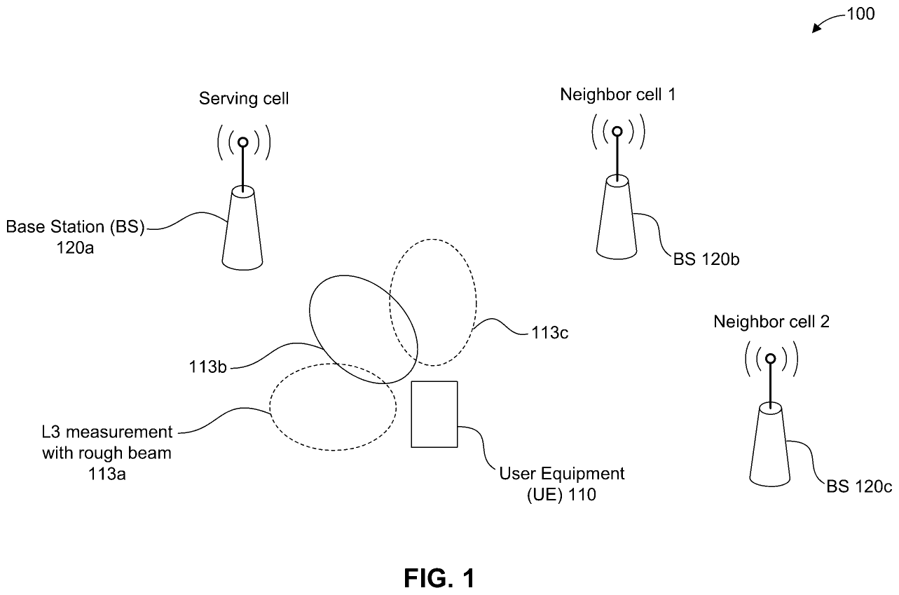

FIG. 1 illustrates example system 100 for conditional L1 measurements, in accordance with some embodiments of the disclosure. System 100 includes user equipment (UE) 110 and base stations (BSs) 120a-120c that connect to the Internet. UE 110 may be a computing electronic device such as a smart phone, cellular phone, and for simplicity purposes-may include other computing devices including but not limited to laptops, desktops, tablets, personal assistants, routers, monitors, televisions, printers, and appliances. BSs 120a-120c can include but is not limited to a wireless base station, an enhanced node BS (eNB), a fifth generation new radio BS (gNB), or a transmission and reception point (TRP) of a wireless network.

UE 110 can access a network via BS 120a (e.g., via random access channel (RACH)) and transmit one or more conditional L1 measurement capabilities of UE 110 to BS 120a. The network (e.g., BS 120a) can configure UE 110 with L3 measurements. In some embodiments, BS 120a can also configure UE 110 with conditional L1 measurements and corresponding conditions based on the one or more conditional L1 measurement capabilities of UE 110. In some embodiments, UE 110 can activate conditional L1 measurements on neighbor cells when corresponding conditions are satisfied (e.g., met.) In addition, UE 110 can deactivate conditional L1 measurements on neighbor cells when corresponding conditions are satisfied. Having conditional L1 measurements avoids UE 110 having to perform L1 measurements (e.g., fine beam training) on neighbor cells as described in example 700. Consequently, conditional L1 measurements that are activated and/or deactivated can reduce measurement delay, reduce UE 110 power consumption, and improve UE 110 throughput.

After the conditional L1 measurements are activated, UE 110 can perform L1 measurement according to the corresponding configuration and transmit the conditional L1 measurements collected (e.g., fine beam measurements from a serving cell and/or a neighbor cell) to the serving cell (e. g, BS 120a.) In some embodiments, based on the conditional L1 measurements collected, BS 120a initiates a handover to a neighboring cell. In some embodiments, UE 110 initiates handover to a neighboring cell (e.g., by transmitting the conditional L1 measurements to BS 120a.)

In some embodiments, the one or more conditional L1 measurement capabilities of UE 110 can include indications C1, C2, and C3. Indication C1 can indicate whether UE 110 supports conditional L1 measurements on neighbor cells (e.g., neighbor cell 1 and/or neighbor cell 2.) Indication C1 can be a parameter identified per UE 110, per frequency range (e.g., FR1, FR2), or per carrier frequency (e.g., ssbFrequency.) In some embodiments, indication C1 can include a target cell ID (e.g., physical cell ID (PCI), a reference signal (e.g., Synchronization Signal Block (SSB), channel state information (CSI)-reference signal (RS), or corresponding configuration like SS/Physical Broadcast Channel (PBCH) Block Measurement Timing Configuration (SMTC)), and a measurement quantity (e.g., L1-reference signal received power (RSRP) or L1-signal to interference plus noise ratio (SINR), and/or L1 reporting configuration.

Indication C2 can indicate the following: i) a maximum number of neighbor cells on which UE 110 supports conditional L1 measurements; ii) a maximum number of resources from neighbor cells on which UE supports conditional L1 measurements; and/or iii) whether indication C2 is signaled statically, semi-persistently (e.g., via RRC signaling), or dynamically (e.g., via media access control (MAC) control element (CE) signaling).

Indication C3 can indicate the type of activate condition or deactivate condition that UE 110 determines to decide whether to activate or deactivate the corresponding conditional L1 measurement for that neighbor cell. Examples of indication C3 include but are not limited to: a L3 measurement (e.g., L3-RSRP, L3-SINR corresponding to a rough beam); a location of UE 110, and/or a time (e.g., estimated based on a high speed train schedule.)

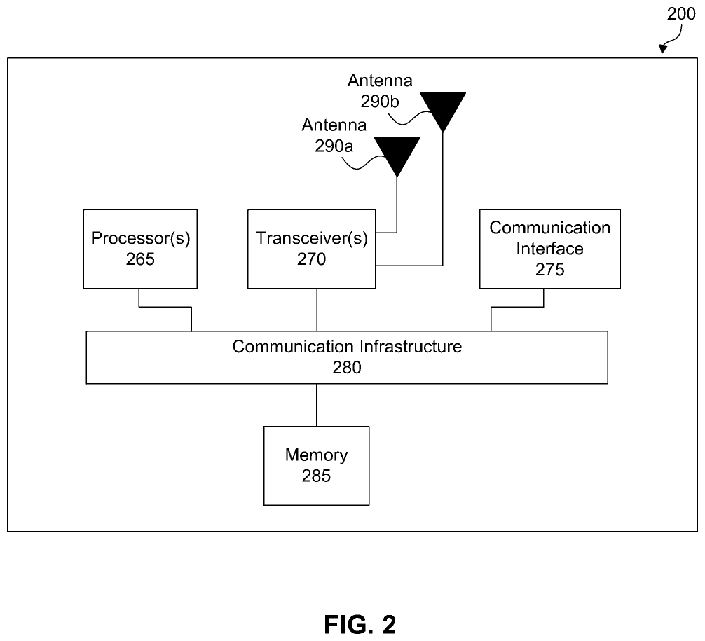

FIG. 2 illustrates a block diagram of an example wireless system 200 for conditional L1 measurements, according to some embodiments of the disclosure. For explanation purposes and not a limitation, FIG. 2 may be described with reference to elements from FIG. 1. For example, system 200 may be any of the electronic devices: UE 110 or BS 120a-120c of system 100. System 200 includes one or more processors 265, transceiver(s) 270, communication interface 275, communication infrastructure 280, memory 285, and antenna 290. Memory 285 may include random access memory (RAM) and/or cache, and may include control logic (e.g., computer instructions) and/or data. One or more processors 265 can execute the instructions stored in memory 285 to perform operations enabling wireless system 200 to transmit and receive wireless communications supporting conditional L1 measurements described herein. In some embodiments, one or more processors 265 can be “hard coded” to perform the functions herein. Transceiver(s) 270 transmits and receives wireless communications signals including wireless communications supporting conditional L1 measurements according to some embodiments, and may be coupled to one or more antennas 290 (e.g., 290a, 290b). In some embodiments, a transceiver 270a (not shown) may be coupled to antenna 290a and different transceiver 270b (not shown) can be coupled to antenna 290b. Communication interface 275 allows system 200 to communicate with other devices that may be wired and/or wireless. Communication infrastructure 280 may be a bus. Antenna 290 may include one or more antennas that may be the same or different types.

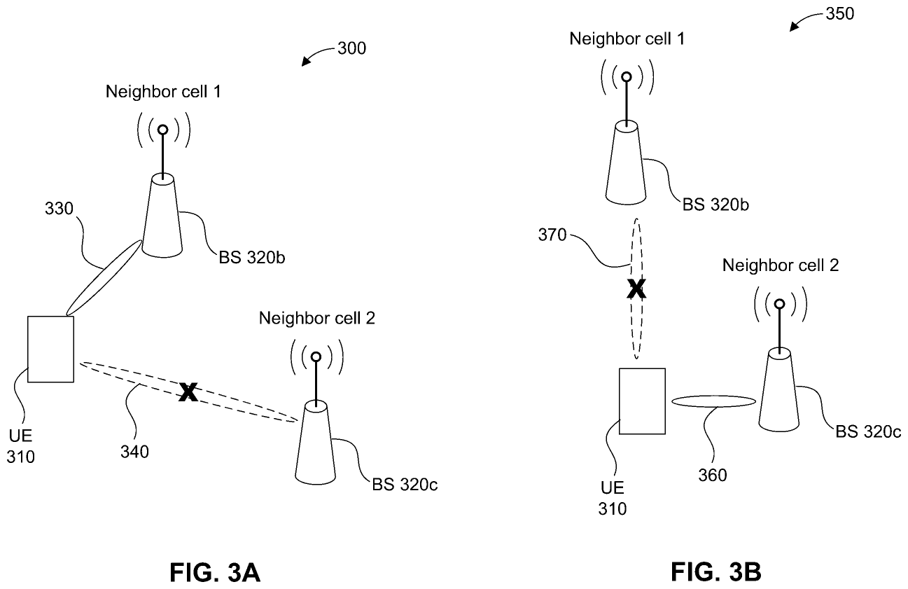

FIG. 3A illustrates example 300 of activation of a conditional L1 measurement, according to some embodiments of the disclosure. For explanation purposes and not a limitation, FIG. 3A may be described with reference to elements from other figures in the disclosure. For example, UE 310, BS 320b, and BS 320c of FIG. 3A may correspond to UE 110 and BS 120b, and BS 120c of FIG. 1. In example 300, UE 310 may access a network via a BS and serving cell (not shown.) Instead of performing L1 measurements for the neighbor cells (e.g., neighbor cells 1 and 2) as in example 700, UE 310 is configured with conditional L1 measurements and corresponding conditions, where satisfaction of the corresponding conditions causes the conditional L1 measurements to be activated and/or deactivated for a given neighbor cell. Accordingly, when UE 310 determines that an activate condition is met for a neighbor cell (e.g., a potential target cell to which UE 310 may initiate a handover), the corresponding conditional L1 measurement can be activated for that neighbor cell (a potential target cell.) An activate condition for one or more conditional L1 measurements may be based on L3 measurements, a location of UE 310, and/or time corresponding to UE 310 as described further below.

In example 300, UE 310 determines that an activation condition can include one or several configured measurement objects corresponding to neighbor cell 1 (e.g., linked with a MeasObjectId with additional information about a corresponding threshold.) When the activation condition corresponding to neighbor cell 1 is satisfied, UE 310 activates corresponding conditional L1 measurements (e.g., collecting and reporting conditional L1 measurements to the serving cell and serving BS.) The activated corresponding conditional L1 measurement is shown as communication 330 with neighbor cell 1 (e.g., via BS 320b.) In example 300, when UE 310 determines that an activation condition is not satisfied, UE 310 does not activate a corresponding conditional L1 measurement (shown as communication 340) with neighbor cell 2 (e.g., BS 320c.) In some embodiments, the activate/deactivate conditions may be based on L3 measurements (e.g., based on a rough beam measurement) and may refer to value thresholds and/or relative value thresholds. UE 310 can be configured with many L3 measurement objects. The network (e.g., via a serving cell BS) can associate a conditional L1 measurement to one or multiple L3 measurement objects with value (e.g., absolute) and/or relative thresholds. UE 310 would perform L3 measurements regularly according to the L3 measurement object configuration. Once the measurement results of the L3 measurement object can meet the configured conditions, UE 310 would activate/deactivate conditional L1 measurements. In a value threshold example, UE 310 determines an activate condition based on an L3-RSRP measurement on a target cell (e.g., neighbor cell 1 or neighbor cell 2) compared with a threshold X1 dBm (e.g., a value threshold of X1=−88 dBm.) After UE 310 determines that the L3-RSRP measurement result on neighbor cell 1 satisfies the activate condition (e.g., exceeds threshold X1 dBm), UE 310 can activate the corresponding conditional L1 measurement(s) (e.g., L1-RSRP, L1-SINR for various fine beams) on neighbor cell 1 shown collectively as communication 330. The UE can measure CSI-RS resources and/or SSB resources of the nzp-CSI-RS-ResourceSet and/or csi-SSB-ResourceSet within the CSI-ResourceConfig settings configured for L1-RSRP. In a relative value threshold example, the L3 measurement condition may be based on a relative value threshold, e.g., X2 dB (e.g., X2=3 dB) being greater than that of the serving cell. When UE 310 determines that L3-RSRP for neighbor cell 1 is greater than that of the serving cell by X2, UE 310 activates the corresponding conditional L1 measurement on neighbor cell 1 shown as communication 330.

In some embodiments, the activate/deactivate conditions may be based on a location of UE 310. For example, UE 310 can utilize non-terrestrial network (NTN) broadcasts of satellite ephemerides, a positioning reference signal (PRS) measurement, and/or Global Navigation Satellite Systems (GNSS), to calculate distances to other BSs (e.g., BS 120b, BS 120c.) For example, locations of other BSs may be obtained via a system information block (SIB). The relative distance may be obtained via downlink propagation delay estimation. UE 310 may determine whether activate/deactivate conditions are satisfied based on threshold values or relative threshold values. UE 310 may determine that when a distance from neighbor cell 1 (BS 120b) is less than a threshold, X1, (e.g., X1=1000 m for non-NTN network), and UE 310 is approaching neighbor cell 1, the condition can be satisfied and UE 310 activates the corresponding conditional L1 measurement at UE 310 for neighbor cell 1, shown as communication 330. UE 310 may determine that the distance from UE 310 to BS 320b satisfies a relative threshold, X2, (e.g., X2=100 m shorter than the distance between UE 310 and the serving cell's BS.) Accordingly, a location activation condition may be satisfied and the corresponding conditional L1 measurement at UE 310 is activated with neighbor cell 1 shown as communication 330. In another example, UE 310 may determine that the distance from UE 310 to BS 320c is longer relative to the distance from UE 310 and the serving cell's BS. Accordingly, a location activation condition is not satisfied and the corresponding conditional L1 measurement at UE 310 is not initiated with neighbor cell 2 shown as communication 340.

In some embodiments, the activate/deactivate conditions may be based on a time when a movement of UE 310 is predictable such as when UE 310 corresponds to a customer premise equipment (CPE) affixed to a high speed train. In this example, UE 310 can be aware of (e.g., configured with) the train schedule and locations of base stations corresponding to the high speed train stations. UE 310, affixed to a high speed train car, can determine that the train car (hence UE 310) will arrive at the next station at 4:10 PM according to the train schedule. Thus, at 4:10 PM, the time condition can be satisfied within an acceptable margin (e.g., within a minute or two of 4:10 PM), where UE 310 can activate a conditional L1 measurement corresponding to neighbor cell 1 and BS 320b shown as communication 330. In some embodiments, at 4:10 PM, a condition is not satisfied, so UE 310 does not activate a conditional L1 measurement corresponding to neighbor cell 2 and BS 320c shown as communication 340.

After the conditional L1 measurements are activated, UE 110 can transmit the conditional L1 measurements collected (e.g., fine beam measurements from the serving cell and/or neighbor cell 1) to the serving cell's BS. In some embodiments, based on the conditional L1 measurements collected, the serving cell's BS initiates a handover to neighboring cell 1. In some embodiments, UE 310 initiates handover to neighboring cell 1.

FIG. 3B illustrates example 350 deactivation of a conditional L1 measurement, according to some embodiments of the disclosure. For explanation purposes and not a limitation, FIG. 3B may be described with reference to elements from other figures in the disclosure. For example, UE 310, BS 320b, and BS 320c of FIG. 3B may correspond to UE 110 and BS 120b, and BS 120c of FIG. 1. In example 350, UE 310 may access a network via a BS and serving cell (not shown), and UE 310 can be configured with conditional L1 measurements and corresponding conditions, where satisfaction of the corresponding conditions cause the conditional L1 measurements to be activated and/or deactivated for a given neighbor cell. Accordingly, when UE 310 determines that a deactivate condition is met for a neighbor cell (e.g., a potential target cell to which UE 310 may initiate a handover, the corresponding conditional L1 measurement can be deactivated for that neighbor cell (a potential target cell.) A deactivate condition for one or more conditional L1 measurements may be based on L3 measurements, a location of UE 310, and/or time corresponding to UE 310.

In example 350, UE 310 determines that a deactivation condition can include one or several configured measurement objects corresponding to neighbor cell 1 (e.g., linked with a MeasObjectId with additional information about a corresponding threshold X.) When the deactivation condition corresponding to neighbor cell 1 is satisfied, UE 310 deactivates corresponding conditional L1 measurements (e.g., collecting and reporting conditional L1 measurements) shown as communication 370 with neighbor cell 1 (e.g., via BS 320b.) In example 300, when UE 310 determines that a deactivation condition is not satisfied, UE 310 continues performing a corresponding conditional L1 measurement (shown as communication 360) with neighbor cell 2 (e.g., BS 320c.)

In some embodiments, the activate/deactivate conditions may be based on L3 measurements and may refer to value thresholds and/or relative value thresholds. In a value threshold example, UE 310 determines that a deactivate condition based on a L3-RSRP measurement on a target cell (e.g., neighbor cell 1 or neighbor cell 2) that is less than a value threshold Y1 dBm (e.g., a value threshold of Y1=−91 dBm.) After UE 310 determines that the L3-RSRP measurement result on neighbor cell 1 is satisfied (e.g., is less than threshold Y1 dBm), UE 310 can deactivate the corresponding conditional L1 measurement (e.g., L1-RSRP, L1-SINR) on neighbor cell 1 shown as communication 370. In a relative value threshold example, the L3 measurement condition may be based on a relative value threshold, Y2 dB (e.g., Y2=3 dB) being less than that of the serving cell. When UE 310 determines that L3-RSRP for neighbor cell 1 is less than Y2, UE 310 deactivates the corresponding conditional L1 measurement on neighbor cell 1 shown as communication 370.

In some embodiments, the activate/deactivate conditions may be based on a location of UE 310. For example, UE 310 can utilize NTN broadcasts of satellite ephemerides, a PRS measurement, and/or GNSS, to calculate distances to other BSs (e.g., BS 120b, BS 120c.) For example, locations of other BSs may be obtained via a SIB. UE 310 may determine whether activate/deactivate conditions are satisfied based on threshold values or relative threshold values. UE 310 may determine that when a distance from neighbor cell 1 (BS 120b) is greater than a threshold, Y1, (e.g., Y1=150 m), and UE 310 is moving away from neighbor cell 1, the condition is satisfied and UE 310 deactivates the corresponding conditional L1 measurement at UE 310 for neighbor cell 1, shown as communication 370. UE 310 may determine that the distance from UE 310 to BS 320b satisfies a relative threshold, Y2, (e.g., Y2=75 m greater than the distance between UE 310 and the serving cell's BS.) Accordingly, a location deactivation condition is satisfied and the corresponding conditional L1 measurement at UE 310 is discontinued with neighbor cell 1 shown as communication 370. In another example, UE 310 may determine that the distance from UE 310 to BS 320c is shorter (e.g., closer) relative to the distance from UE 310 and the serving cell's BS. Accordingly, a location deactivation condition is not satisfied and the corresponding conditional L1 measurement at UE 310 continues with neighbor cell 2 shown as communication 360.

In some embodiments, the activate/deactivate conditions may be based on a time when a movement of UE 310 is predictable such as when UE 310 corresponds to a CPE affixed to a high speed train. In this example, UE 310 can be aware of (e.g., configured with) the train schedule and locations of base stations corresponding to the train stations. UE 310, affixed to a high speed train car, can determine that the train car (hence UE 310) will arrive at the next station at 4:10 PM according to the train schedule. Thus, at 4:10 PM the time condition can be satisfied within an acceptable margin (e.g., within a minute or two of 4:10 PM), so UE 310 can deactivate a conditional L1 measurement corresponding to neighbor cell 1 and BS 320b shown as communication 370. In some embodiments, at 4:10 PM, UE 310 can continue a conditional L1 measurement corresponding to neighbor cell 2 and BS 320c shown as communication 360.

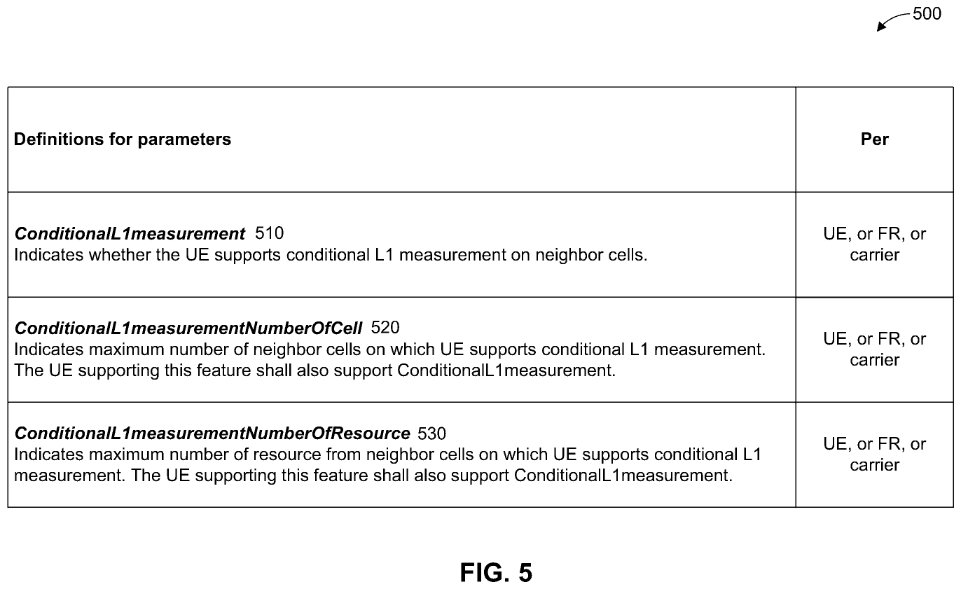

FIG. 5 illustrates example 500 of UE capabilities for conditional L1 measurements, according to some embodiments of the disclosure. For explanation purposes and not a limitation, FIG. 5 may be described with reference to elements from other figures in the disclosure. For example, example 500 may be one or more conditional L1 measurement capabilities that UE 110 provides to BS 120a. Accordingly, BS 120a may include one or more of the conditional L1 measurement capabilities in a configuration signal, such as an RRC signal transmitted from BS 120a to UE 110 of FIG. 1. Example 500 can include ConditionalL1measurement 510, ConditionalL1measurementNumberOfCell 520, and ConditionalL1 measurementNumberOfResource 530. In some embodiments, ConditionalL1measurement 510 can correspond to indication C1 that indicates whether UE 110 supports conditional L1 measurements on neighbor cells. ConditionalL1measurement 510 can be described per UE (e.g., UE 110), per FR (e.g., FR1, FR2), or per carrier frequency.

In some embodiments, ConditionalL1measurementNumberOfCell 520 refer to indications C2 that indicate a maximum number of cells with configured conditional L1 measurements. In other words, UE 110 can inform BS 120a (e.g., the serving cell) of the maximum number of neighbor cells on which UE 110 can support conditional L1 measurements (e.g., based on activate/deactivate conditions.)

In some embodiments, ConditionalL1measurementNumberOfResource 530 refer to indications C2 that indicate a maximum number of resources from neighbor cells on which UE supports conditional L1 measurements (e.g. maximum number of SSB/CSI-RS with configured conditional L1 measurements.)

In some embodiments, the indications of
ConditionalL1measurementNumberOfCell 520 and/or
ConditionalL1measurementNumberOfResource 530 can be described per UE (e.g., UE 110), per FR, or per carrier frequency.

In some examples, the per UE, per FR, and/or per carrier indications can be static indications, semi-persistent indications, or dynamic indications. Static C2 indications do not change even when changes occur in the network (e.g., carrier aggregation (CA)/dual connection (DC) configuration.)

In some embodiments, the per UE, per FR, and/or per carrier frequency C2 indications can be semi-persistent indications. For example, after accessing a network via BS 120a, for a given carrier aggregation (CA)/dual connection (DC) configuration, UE can report semi-persistent indications for per UE or per FR where ConditionalL1measurementNumberOfCell=8. The network can subsequently change (e.g., add a secondary cell (SCell).) Thus, BS 120a can transmit an RRC configuration signal to UE 110 indicating the additional SCell activation. After receiving the RRC configuration signal, UE 110 can inform the network (e.g., BS 120a) of a change (e.g., transmit ConditionalL1 measurementNumberOfCell=5.)

In some embodiments, the per UE, per FR, and/or per carrier frequency C2 indications can be dynamic indications. Thus, after each CA activation/deactivation in the network, UE 110 reports the supported C2 indication per UE or per FR. For example, after accessing a network via BS 120a, for a given CA/DC configuration, UE can report dynamic indications for per UE or per FR where ConditionalL1measurementNumberOfCell =8. The network can subsequently change (e.g., add a secondary cell (SCell).) Thus, BS 120a can transmit a MAC CE signal to UE 110 indicating the additional SCell activation. After receiving the MAC CE signal, UE 110 can inform the network (e.g., BS 120a) of a change (e.g., transmitting ConditionalL1measurementNumberOfCell=6.)

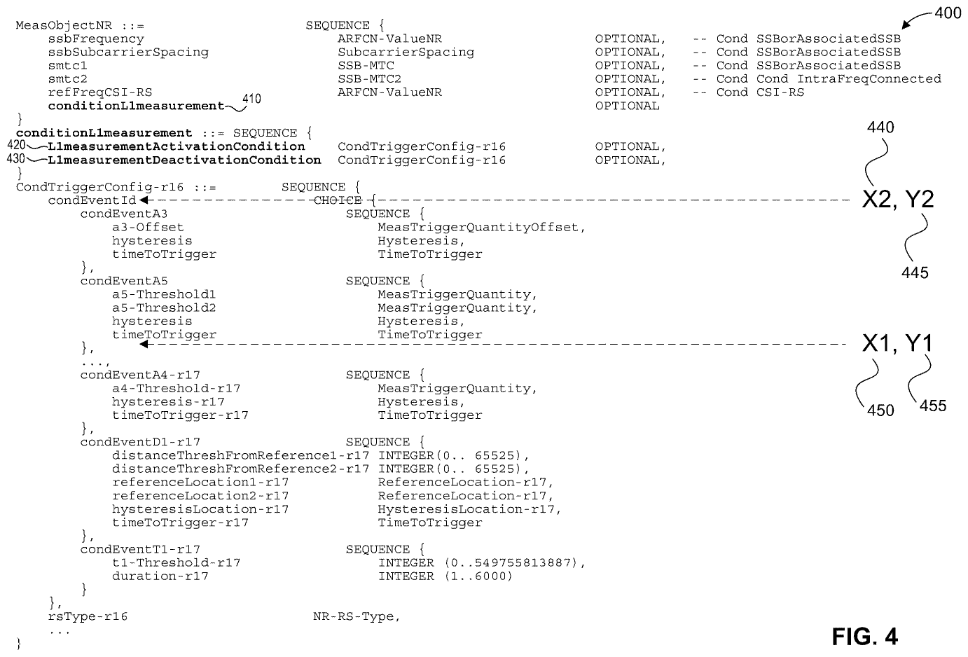

FIG. 4 illustrates example 400 of signaling for conditional L1 measurements, according to some embodiments of the disclosure. For explanation purposes and not a limitation, FIG. 4 may be described with reference to elements from other figures in the disclosure. For example, example 400 may be an RRC signal transmitted from BS 120 a to UE 110 of FIG. 1. Example 400 may include ConditionalL1measurement 410 which can be ConditionalL1measurement 510 of FIG. 5. For example, ConditionalL1measurement 410 can be indication C1 that indicates that UE 110 supports conditional L1 measurements. Example 400 may also include an activation condition, L1measurementActivationCondition 420, that can correspond to activation conditions described in FIG. 3A. Example 400 can also include a deactivation condition, L1measurementDeactivationCondition 430, that corresponds to deactivation conditions as described in FIG. 3B. Example 400 also includes examples of thresholds X1 450, X2 440, Y1 455, and Y2 445 as described with regard to value thresholds and relative value thresholds in FIG. 3A and FIG. 3B. For example, when the activate condition is L3-RSRP, the value threshold X1 can correspond to X1 450, and deactivate condition value threshold Y1 can correspond to Y1 455. For relative values, the activate condition relative value threshold X2 can correspond to X2 440, and the deactivate condition relative value threshold Y2 can correspond to Y2 445.

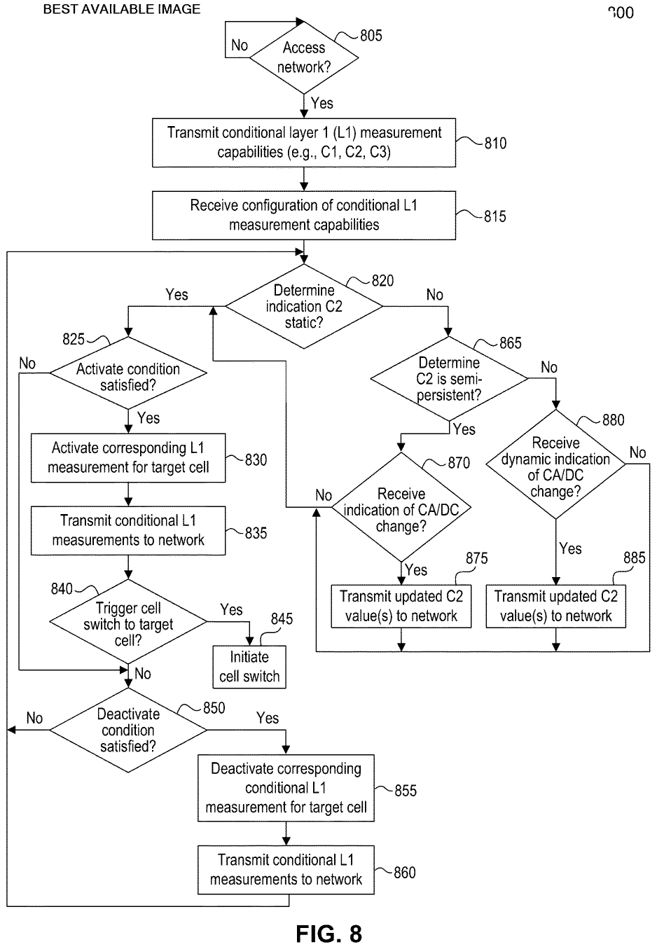

FIG. 8 illustrates example method 800 for a UE supporting conditional L1 measurements, according to some embodiments of the disclosure. For explanation purposes and not a limitation, FIG. 8 may be described with reference to elements from other figures in the disclosure. For example, method 800 can be performed by UE 110 of FIG. 1, system 200 of FIG. 2, or UE 310 FIG. 3A or FIG. 3B. For convenience, method 800 is described with regard to UE 110.

At 805, UE 110 can determine whether a network is accessed. When a network is accessed (e.g., via RACH w. BS 120a), method 800 proceeds to 810. Otherwise, method 800 remains at 805.

At 810, UE 110 can transmit conditional L1 measurement capabilities (e.g., C1, C2, and/or C3) to the network (e.g., to BS 120a).

At 815, UE 110 can receive a configuration signal for conditional L1 measurements from BS 120a (e.g., via RRC signaling shown in FIG. 4 with conditions for performance of conditional L1 measurements by UE 110 and corresponding thresholds such as X1, X2, Y1, Y2.) The configuration signal from the BS 120a is responsive to the conditional L1 measurement capabilities sent by the UE 110.

At 820, UE 110 can determine whether indication C2 (e.g., per UE, per FR, per carrier frequency) is a static indication. When the C2 indication is static, method 800 proceeds to 825. Otherwise, method 800 proceeds to 865.

At 825, UE 110 can determine whether an activate condition is satisfied (e.g., see FIG. 3A.) When the activate condition is satisfied, method 800 proceeds to 830.

Otherwise, method 800 proceeds to 850.

At 830, UE 110 can activate the corresponding conditional L1 measurement for target cell associated with the activated condition (e.g., communication 330 of FIG. 3A.) Herein, L1 measurements include one or more of L1-RSRP, L1-SINR.

At 835, UE 110 can transmit conditional L1 measurements to the network (e.g., to BS 120a of the serving cell.)

At 840, UE 110 can determine based on a threshold value of the conditional L1 measurements, whether to trigger a cell switch (e.g., a handover) to a target cell (e.g., neighbor cell 1 of FIG. 3A.) When a cell switch is triggered, method 800 proceeds to 845. Otherwise, method 800 proceeds to 850.

At 845, UE 110 can initiate a cell switch to neighbor cell 1 of FIG. 3A (e.g., handover with BS 320b.)

At 850, UE 110 can determine whether a deactivate condition is satisfied (e.g., see FIG. 3B.) When a deactivate condition is satisfied, method 800 proceeds to 855. Otherwise, method 800 returns to 820.

At 855, UE 110 can deactivate corresponding conditional L1 measurements for a target cell (e.g., communication 370 with neighbor cell 1 of BS 320b.)

At 860, UE 110 can transmit remaining active corresponding conditional L1 measurements to the network (e.g., to BS 120a of the serving cell.)

At 865, UE 110 can determine whether indication C2 is a semi-persistent indication. When C2 is semi-persistent, method 800 proceeds to 870. Otherwise, method 800 proceeds to 880.

At 870, UE 110 can determine whether an indication of a CA/DC change in the network is received (e.g., via an RRC signal from BS 120a.) When an indication of a CA/DC change is received, method 800 proceeds to 875. Otherwise, method 800 returns to 825.

At 875, UE 110 can transmit updated C2 value(s) to the network (e.g., to BS 120a of updated C2 values based on the RRC signal received.)

At 880, UE 110 can determine whether a dynamic indication of CA/DC change in the network is received (e.g., via a MAC CE signal from BS 120a.) When an indication of a CA/DC change is received, method 800 proceeds to 885. Otherwise, method 800 returns to 825.

At 885, UE 110 can transmit updated C2 value(s) to the network (e.g., to BS 120a of updated C2 values based on the MAC CE signal received.)

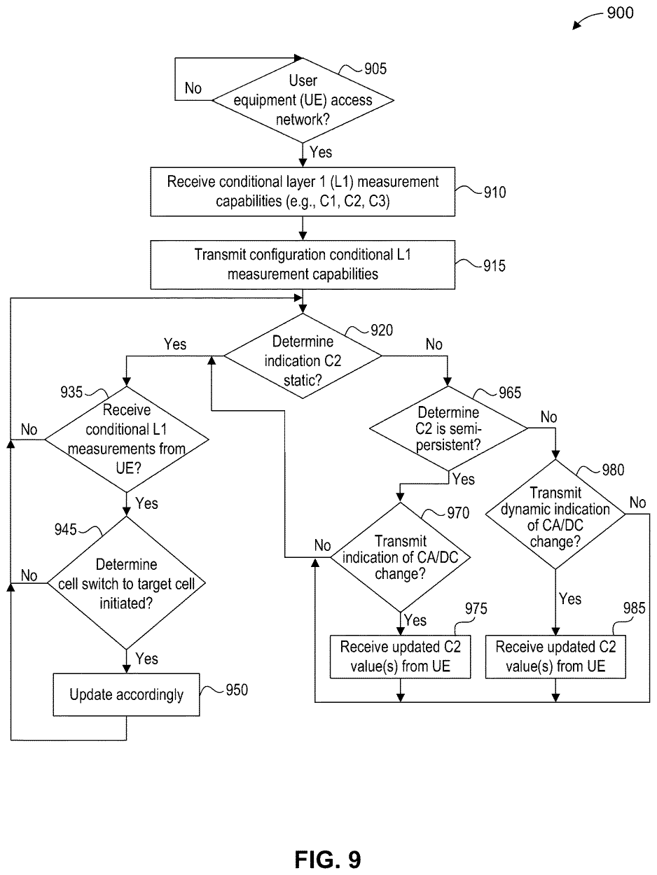

FIG. 9 illustrates example method 900 for a BS supporting conditional L1 measurements, according to some embodiments of the disclosure. For explanation purposes and not a limitation, FIG. 9 may be described with reference to elements from other figures in the disclosure. For example, method 900 can be performed by BS 120a of FIG. 1, or system 200 of FIG. 2.

At 905, BS 120a can determine whether UE 110 has accessed the network via the serving cell. When UE 110 has accessed the network, method 900 proceeds to 910. Otherwise, method 900 remains at 905.

At 910, BS 120a can receive conditional layer 1 (L1) measurement capabilities (e.g., C1, C2, and/or C3) from UE 110.

At 915, BS 120a can transmit a configuration signal for conditional L1 measurements to UE 110 based at least on the conditional L1 measurement capabilities provided by UE 110.

At 920, BS 120a can determine whether indication C2 is static. When C2 is static, method 900 proceeds to 935. Otherwise, method 900 proceeds to 965.

At 935, BS 120a can determine whether conditional L1 measurements are received from UE 110 for a target cell. When UE 110 has determined that an activate condition is satisfied, corresponding L1 measurements are received by BS 120a and method 900 proceeds to 945. Otherwise, method 900 returns to 920.

At 945, BS 120a can determine whether a cell switch to a target cell is initiated. In some embodiments, BS 120a initiates a handover to a neighbor cell based on the received corresponding L1 measurements. In some embodiments, UE 110 initiates the handover to a neighbor cell. When a cell switch is initiated method 900 proceeds to 950. Otherwise, method 900 returns to 920.

At 950, BS 120a can update data accordingly (e.g., UE 110 is now associated with a neighbor cell, a new serving cell.) At 965, BS 120a can determine whether indication C2 is semi-persistent. When indication C2 is semi-persistent, method 900 proceeds to 970. Otherwise, method 900 proceeds to 980.

At 970, BS 120a can determine whether a CA/DC change occurred. When one has occurred, BS 120a can transmit an indication of CA/DC change to UE 110 via RRC signaling. Otherwise, when no CA/DC change has occurred, method 900 returns to 935.

At 975, BS 120a can receive updated C2 value(s) from UE 110 based on the RRC signaling transmitted.

At 980, BS 120a can determine whether a CA/DC change has occurred. When one has occurred and the C2 indication is dynamic, BS 120a can transmit the of CA/DC change via a MAC CE signal to UE 110; method 900 proceeds to 985. Otherwise, method 900 returns to 935.

At 985, BS 120a can receive updated C2 value(s) from UE based at least on the MAC CE signal transmitted to UE 110.

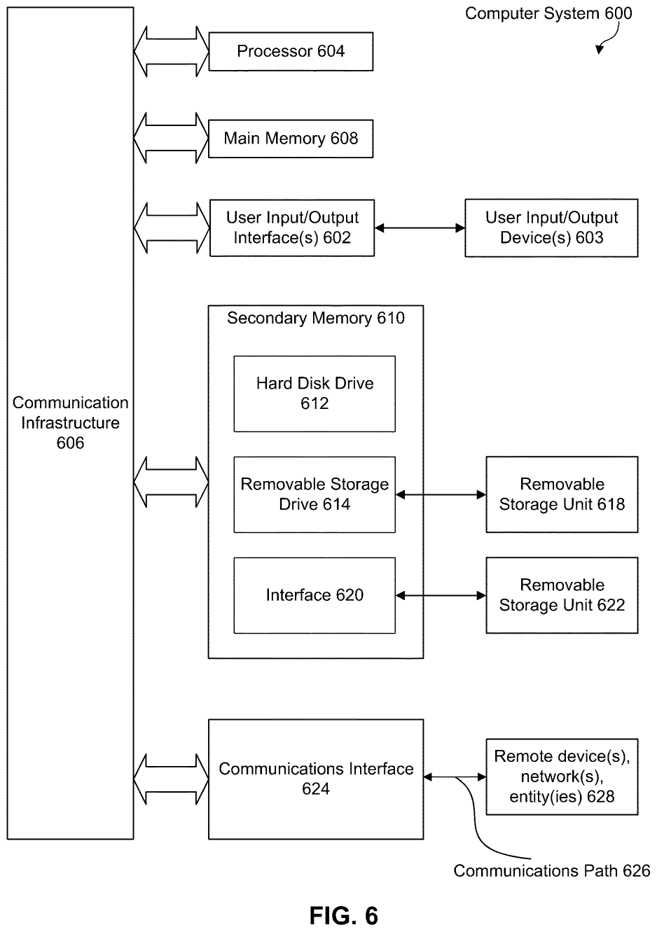

Various embodiments can be implemented, for example, using one or more well-known computer systems, such as computer system 600 shown in FIG. 6. Computer system 600 can be any well-known computer capable of performing the functions described herein. For example, and without limitation, BS 120 and/or UE 110 of FIG. 1, system 200 of FIG. 2, examples 300 and 350 of FIGS. 3A and 3B, generate or receive example 400 of FIG. 4, example 500 of FIG. 5, method 800 of FIG. 8, and method 900 of FIG. 9 (and/or other apparatuses and/or components shown in the figures) may be implemented using computer system 600, or portions thereof.

Computer system 600 includes one or more processors (also called central processing units, or CPUs), such as a processor 604. Processor 604 is connected to a communication infrastructure 606 that can be a bus. One or more processors 604 may each be a graphics processing unit (GPU). In an embodiment, a GPU is a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 600 also includes user input/output device(s) 603, such as monitors, keyboards, pointing devices, etc., that communicate with communication infrastructure 606 through user input/output interface(s) 602. Computer system 600 also includes a main or primary memory 608, such as random access memory (RAM). Main memory 608 may include one or more levels of cache. Main memory 608 has stored therein control logic (e.g., computer software) and/or data.

Computer system 600 may also include one or more secondary storage devices or memory 610. Secondary memory 610 may include, for example, a hard disk drive 612 and/or a removable storage device or drive 614. Removable storage drive 614 may be a floppy disk drive, a magnetic tape drive, a compact disk drive, an optical storage device, tape backup device, and/or any other storage device/drive.

Removable storage drive 614 may interact with a removable storage unit 618. Removable storage unit 618 includes a computer usable or readable storage device having stored thereon computer software (control logic) and/or data. Removable storage unit 618 may be a floppy disk, magnetic tape, compact disk, DVD, optical storage disk, and/any other computer data storage device. Removable storage drive 614 reads from and/or writes to removable storage unit 618 in a well-known manner.

According to some embodiments, secondary memory 610 may include other means, instrumentalities or other approaches for allowing computer programs and/or other instructions and/or data to be accessed by computer system 600. Such means, instrumentalities or other approaches may include, for example, a removable storage unit 622 and an interface 620. Examples of the removable storage unit 622 and the interface 620 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 600 may further include a communication or network interface 624. Communication interface 624 enables computer system 600 to communicate and interact with any combination of remote devices, remote networks, remote entities, etc. (individually and collectively referenced by reference number 628). For example, communication interface 624 may allow computer system 600 to communicate with remote devices 628 over communications path 626, which may be wired and/or wireless, and which may include any combination of LANs, WANs, the Internet, etc. Control logic and/or data may be transmitted to and from computer system 600 via communication path 626.

The operations in the preceding embodiments can be implemented in a wide variety of configurations and architectures. Therefore, some or all of the operations in the preceding embodiments may be performed in hardware, in software or both. In some embodiments, a tangible, non-transitory apparatus or article of manufacture includes a tangible, non-transitory computer useable or readable medium having control logic (software) stored thereon is also referred to herein as a computer program product or program storage device. This includes, but is not limited to, computer system 600, main memory 608, secondary memory 610 and removable storage units 618 and 622, as well as tangible articles of manufacture embodying any combination of the foregoing. Such control logic, when executed by one or more data processing devices (such as computer system 600), causes such data processing devices to operate as described herein.

Based on the teachings contained in this disclosure, it will be apparent to persons skilled in the relevant art(s) how to make and use embodiments of the disclosure using data processing devices, computer systems and/or computer architectures other than that shown in FIG. 6. In particular, embodiments may operate with software, hardware, and/or operating system implementations other than those described herein.

It is to be appreciated that the Detailed Description section, and not the Summary and Abstract sections, is intended to be used to interpret the claims. The Summary and Abstract sections may set forth one or more but not all exemplary embodiments of the disclosure as contemplated by the inventor(s), and thus, are not intended to limit the disclosure or the appended claims in any way.

While the disclosure has been described herein with reference to exemplary embodiments for exemplary fields and applications, it should be understood that the disclosure is not limited thereto. Other embodiments and modifications thereto are possible, and are within the scope and spirit of the disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. In addition, alternative embodiments may perform functional blocks, steps, operations, methods, etc. using orderings different from those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein.

The breadth and scope of the disclosure should not be limited by any of the above-described exemplary embodiments, but should be defined only in accordance with the following claims and their equivalents.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should only occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of, or access to, certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

What is claimed is:

1. A user equipment (UE) comprising:
a transceiver; and
a processor coupled to the transceiver, configured to:
receive, via the transceiver, a configuration signal comprising an activation condition for conditional layer 1 (L1) measurements;
determine that the activation condition is satisfied for a target cell;
activate a conditional L1 measurement corresponding to the target cell; and
transmit, via the transceiver, data corresponding to the conditional L1 measurement.

2. The UE of claim 1, wherein to determine that the activation condition is satisfied, the processor is configured to:
compare a layer 3 (L3) measurement corresponding to the target cell with a corresponding L3 measurement of a serving cell; and
determine that the comparison satisfies a threshold value.

3. The UE of claim 1, wherein to determine that the activation condition is satisfied, the processor is configured to:
determine a location of the UE; and
determine that a relative distance of the location from the target cell satisfies a threshold value.

4. The UE of claim 1, wherein to determine that the activation condition is satisfied, the processor is configured to:
determine a location of the UE; and
determine a time, based at least on the location of the UE, to initiate the activation condition for the target cell.

5. The UE of claim 1, wherein the processor is further configured to:
determine that a deactivation condition is satisfied for the target cell; and
deactivate the conditional L1 measurement corresponding to the target cell.

6. The UE of claim 1, wherein the processor is further configured to:
receive a radio resource control (RRC) signal comprising a change in carrier aggregation (CA)/dual connectivity (DC) of a serving cell; and
transmit an updated conditional L1 measurement capability in response to the RRC signal.

7. The UE of claim 1, wherein the processor is further configured to:
receive a media access control (MAC) control element (CE) signal comprising a change in carrier aggregation (CA)/dual connectivity (DC) of a serving cell; and
transmit an updated conditional L1 measurement capability in response to the MAC CE signal.

8. A base station (BS) comprising:
a transceiver; and
a processor coupled to the transceiver, configured to:
receive one or more conditional layer 1 (L1) measurement capabilities corresponding to a user equipment (UE);
transmit, via the transceiver, a configuration signal comprising an activation condition corresponding to the one or more conditional L1 measurement capabilities; and
receive a conditional L1 measurement corresponding to a target cell and based on the activation condition.

9. The BS of claim 8, wherein the activation condition corresponds to a layer 3 (L3) measurement of a serving cell of the BS and a L3 measurement corresponding to the target cell.

10. The BS of claim 9, wherein the L3 measurement of the serving cell comprises a reference signal received power (RSRP) or a signal to interference plus noise ratio (SINR).

11. The BS of claim 8, wherein the activation condition corresponds to a location of the UE and a distance of the location from the target cell.

12. The BS of claim 8, wherein the processor is further configured to:
transmit a radio resource control (RRC) signal comprising a change in carrier aggregation (CA)/dual connectivity (DC) corresponding to a serving cell; and
receive an updated conditional L1 measurement capability of the one or more conditional L1 measurement capabilities in response to the RRC signal.

13. The BS of claim 8, wherein the processor is further configured to:
transmit a media access control (MAC) control element (CE) signal comprising a change in carrier aggregation (CA)/dual connectivity (DC) corresponding to a serving cell; and
receive an updated conditional L1 measurement capability of the one or more conditional L1 measurement capabilities in response to the MAC CE signal.

14. A method comprising:
receiving a configuration signal comprising an activation condition for layer 1 (L1) conditional measurements;
determining that the activation condition is satisfied for a target cell;
activating a conditional L1 measurement corresponding to the target cell; and
transmitting data corresponding to the conditional L1 measurement.

15. The method of claim 14, wherein the determining that the activation condition is satisfied, comprises:
comparing a layer 3 (L3) measurement corresponding to the target cell with a corresponding L3 measurement of a serving cell; and
determining that the comparison satisfies a threshold value.

16. The method of claim 14, wherein the determining that the activation condition is satisfied, comprises:
determining a location of a user equipment (UE); and
determining that a relative distance of the location from the target cell satisfies a threshold value.

17. The method of claim 14, wherein the determining that the activation condition is satisfied, comprises:
determining a location of a user equipment (UE); and
determining a time, based at least on the location of the UE, to initiate the activation condition for the target cell.

18. The method of claim 14, further comprising:
determining that a deactivation condition is satisfied for the target cell; and
deactivating the conditional L1 measurement corresponding to the target cell.

19. The method of claim 14, further comprising:
receiving a radio resource control (RRC) signal comprising a change in carrier aggregation (CA)/dual connectivity (DC) of a serving cell; and
transmitting an updated conditional L1 measurement capability in response to the RRC signal.

20. The method of claim 14, further comprising:
receiving a media access control (MAC) control element (CE) signal comprising a change in carrier aggregation (CA)/dual connectivity (DC) of a serving cell; and
transmitting an updated conditional L1 measurement capability in response to the MAC CE signal.
